(19) United States
(12) Patent Application Publication
(10) Pub. No.: US 2023/0392233 A1
(43) Pub. Date: Dec. 7, 2023

(54) TARGET ION RECOVERY FROM EARTH MATERIAL

(71) Applicant: Schlumberger Technology Corporation, Sugar Land, TX (US)

(72) Inventors: Dominic Vincent Perroni, Houston, TX (US); Florence Binet, Houston, TX (US); Ankur D. Jariwala, Katy, TX (US)

(21) Appl. No.: 18/328,824

(22) Filed: Jun. 5, 2023

Related U.S. Application Data
(60) Provisional application No. 63/365,787, filed on Jun. 3, 2022.

(51) Int. Cl. C22B 26/12; C22B 3/08; C22B 3/12; C22B 3/42; C22B 3/44; C01D 15/08; C01D 15/02; C01D 15/04; C01D 15/06

(52) U.S. Cl. CPC C22B 26/12; C22B 3/08; C22B 3/12; C22B 3/42; C22B 3/44; C01D 15/08; C01D 15/02; C01D 15/04; C01D 15/06

(57) ABSTRACT

Described herein are methods of recovering a target ion, such as lithium, from earth materials. The methods include leaching the target ion from an earth material such as a clay to form a target solution and extracting the target ion from the dilute lithium solution using a extraction process selective for the target ion to yield a concentrate which can be converted to a product.

### CROSS-REFERENCE TO RELATED APPLICATIONS

This patent application claims benefit of U.S. Provisional Patent Application Ser. No. 63/365,787 filed Jun. 3, 2022, which is entirely incorporated herein by reference.

### FIELD

This patent application describes methods and apparatus for critical minerals recovery from aqueous sources derived from earth materials, such as clays. Specifically, processes for recovering critical minerals from earth material leaching effluents are described.

### BACKGROUND

Critical minerals are essential components in many carbon-reduced or carbon-neutral technologies. For example, lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

Supply of many target ions is currently forecast to run behind demand, and prices for many target ions currently outstrip even the most optimistic forecasts. While prices are quite volatile as the global market develops, target ion prices are expected to remain high through 2030. The incentive for more target ion production could not be clearer.

Target ions may be recovered from brines. Precipitation from brine by atmospheric evaporation of water has been the most common method of recovering many target ions, particularly lithium. For example, regarding lithium, a lithium-bearing aqueous stream is provided to a large shallow pool where water is evaporated over many months to yield a concentrated lithium solution. Lithium is among the most soluble ions in water, so lithium salts tend to remain in solution after other salts, such as sodium, potassium, calcium, and magnesium salts, have precipitated from solution. These precipitated solids are often removed from a concentrated lithium-bearing brine so that the final lithium salt solution has a minimal amount of other metals. The process of precipitating salts, however, often results in significant lithium loss into the precipitated solids. By some estimates, conventional evaporation processes recover, on average, only 40% of lithium in feed streams. Critical minerals being increasingly precious commodities, effective and efficient methods and apparatus for recovering valuable lithium, and other target ions, from evaporation byproducts are needed.

### SUMMARY

Embodiments described herein provide a method, comprising leaching a target ion from an earth material to form a target solution; and extracting the target ion from the target solution using a selective extraction process selective for the target ion to yield a concentrate.

Other embodiments described herein provide a method, comprising leaching a target ion from an earth material to form a target solution; extracting the target ion from the target solution using an extraction stage of a selective extraction process selective for the target ion; and concurrently extracting lithium from an aqueous source using the extraction stage, wherein leaching the target ion from the earth material comprises contacting the earth material with a material from the selective extraction process.

Other embodiments described herein provide a method, comprising leaching a target ion from an earth material to form an aqueous solution; concurrently extracting the target ion from an aqueous source distinct from the target solution using a selective extraction process selective for the target ion; and adding a material derived from the aqueous solution to the selective extraction process

### BRIEF DESCRIPTION OF THE DRAWINGS

FIG. 1 is a schematic process diagram of a lithium recovery process according to one embodiment.

FIG. 2 is a schematic process diagram of a lithium recovery process according to another embodiment.

### DETAILED DESCRIPTION

Critical minerals such as lithium can be leached from earth materials such as clays and other particulate earth materials by known methods. Generally, the earth material is exposed to a leaching fluid and aggressively mixed, for example by milling, to cause lithium from the earth material to move into the leaching fluid. The leaching fluid is generally aqueous, and may be water or a salt solution, which may have a reduced pH in some cases. Examples of leaching fluids that can be used include a 2M solution of sulfuric acid (H₂SO₄) and a solution of NaCl in water with a mass concentration of 3.3%. Where a salt such as NaCl is used to enhance leaching, the salt may be combined with the earth material in solid form and milled together with the earth material before adding water. Examples of types of clay from which lithium can be obtained by leaching include Montmorillonite clay, boron clay, and hectorite.

In the following, a method for lithium recovery will be discussed. However, similar method may be applied to any other target ion. Leaching lithium from clay generally results in an aqueous lithium-containing stream with lithium concentration up to about 3,000 ppm. Such an aqueous lithium-containing stream can be subjected to a lithium-selective extraction process to efficiently remove, concentrate, and purify the lithium into a lithium concentrate that can be further processed or converted into a lithium product.

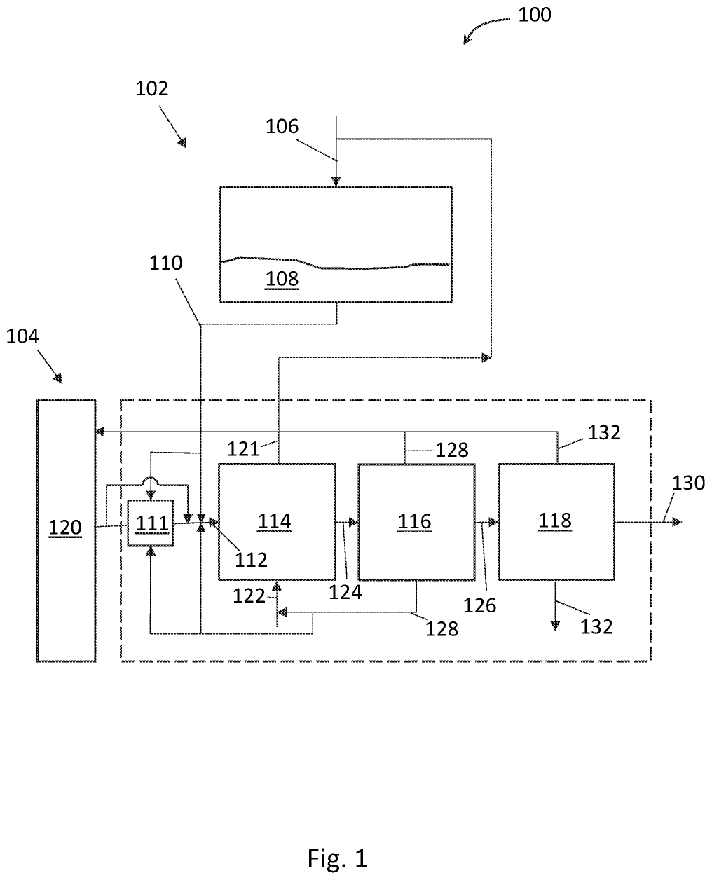

FIG. 1 is a schematic process-flow diagram of a lithium recovery process 100 according to one embodiment. The lithium recovery process 100 includes a leaching process 102 and a lithium-selective extraction process 104. In the leaching process 102, an aqueous leaching fluid 106 is contacted with a particulate earth material 108 to yield a dilute lithium solution 110, also designated target solution. The dilute lithium solution 110, having lithium concentration of 100 ppm to 3,000 ppm, is routed to the lithium-selective extraction process 104 for recovery, purification, and concentration of lithium into a lithium concentrate or a lithium product. The earth material is generally contacted with the aqueous leaching fluid 106 and mixed in a way that promotes intimate contact between individual particles of the earth material and the aqueous medium. In some cases, the leaching can be performed in more than one contacting stage to increase lithium extraction. In some cases, the leaching can be performed at reduced pH to encourage lithium to move from the earth material into the aqueous medium.

The lithium-selective extraction process 104 generally has an extraction stage 114, a purification stage 116, and an optional conversion stage 118. The extraction stage 114 performs a direct lithium extraction process that can be an ion withdrawal process, in which lithium ions are withdrawn from an aqueous lithium containing material by contact with a withdrawal medium, which can be selective for lithium. The direct lithium extraction process can alternately be an electrochemical separation process, in which an electric field is used to force diffusion of ions through a selective membrane or lithium selective extraction from any other known technique.

In an ion withdrawal version of the extraction stage 114, an extraction stage feed 112, obtained from an aqueous lithium source 120, is contacted with a lithium-selective material to remove lithium from the feed 112. The lithium-selective material can be solid or liquid. Contacting the feed 112 with the lithium-selective material results in a loaded lithium-selective material and a depleted aqueous material 121. The depleted aqueous material 121 can be returned to the environment as a reject stream, and may be purified or have its pH adjusted before being returned to the environment. The depleted aqueous material 121 can also be used in the processes 102 and 104 in other ways, as described below.

The dilute lithium solution 110 from the leaching process 102 is provided to the extraction stage 114 along with the extraction stage feed 112. The dilute lithium solution 110 can be mixed with the extraction stage feed 112, or the two streams can be provided to the extraction stage 114 separately. In some cases, the dilute lithium solution 110 can be provided to the extraction stage 114 exclusively, while flow of the extraction stage feed 112 to the extraction stage 114 is discontinued. In some cases, the dilute lithium solution 110 and the extraction stage feed 114 can be mixed to one or more targets, such as a property, composition, or recipe. For example, the dilute lithium solution 110 and the extraction stage feed 112 can be mixed to form a mixed lithium feed having a selected lithium concentration, a selected impurity concentration, a selected ratio of lithium concentration to impurity concentration, a selected pH, a selected flow rate, and/or a selected temperature.

After lithium originating with the extraction stage feed 112, the dilute lithium solution 110, or both, is removed by the lithium-selective material, the lithium-selective material is in a state of being loaded with lithium. A stripping material 122 is used to unload the lithium from the lithium-selective material. The stripping material 122 is an aqueous stream that may be water, a brine solution, an acidic solution, and acidic brine solution, a buffer solution, or another material selected to remove the lithium from the lithium-selective material. The stripping material may be selective to lithium so that lithium is removed from the lithium-selective material at a higher proportion than impurity materials. In most cases, the stripping material will be water or brine, and may be sourced from other units of the lithium-selective process 104.

Direct lithium extraction processes can also use a lithium selective electrochemical separation process. The lithium selective electrochemical separation process uses a voltage bias to drive materials through a lithium selective membrane to separate lithium from an aqueous lithium source such as the extraction feed and/or the dilute lithium solution 110. The aqueous lithium source is brought into contact with a first side of the lithium selective membrane, and an aqueous eluent material is brought into contact with a second side of the lithium selective membrane, opposite from the first side. The voltage bias is applied within the aqueous lithium source and the aqueous eluent material to form an electric field within both materials and extending across the lithium selective membrane. The electric field provides a driving force to move, or increase movement of, charged species through the lithium selective membrane. The species motivated by the electric field to move through the lithium selective membrane depends on the configuration of the lithium selective membrane. For example, the lithium selective membrane may selectively pass lithium ions more than other ions or the lithium selective membrane may selective block passage of lithium ions more than other ions. The extraction stage 114 can be such an electrochemical separation process. In such case, the eluent is collected and forms the

Direct lithium extraction processes that include lithium selective electrochemical separation processes use lithium selective membranes. Such membranes can include, or be made of, lithium selective materials such as lithium aluminum germanium phosphate, lithium aluminum titanium phosphate, lithium lanthanum titanates, or a metal organic framework type material such as UiO.

Removing lithium from the lithium-selective material in the extraction stage 114 yields a lithium intermediate 124 that is routed to the purification stage 116. In the ion withdrawal process, the intermediate includes the stripping material once it has gone through the withdrawal material. In the electrochemical separation process, the intermediate includes the eluent once charged with lithium ions. In the purification stage 116, the concentration of lithium is typically increased and the concentration of any impurities is reduced, or at least increased by a proportion less than that of lithium. In some versions, the purification stage can remove some divalent species, such as calcium and magnesium, by exchanging for sodium. The calcium and magnesium typically precipitate and are removed using solids removal processes.

The purification stage 116 can include any mixture of, ion exchange processes, filtration processes, osmotic processes, evaporation processes, redox processes (including electrochemical processes), and solids removal processes to remove water and impurities from the lithium intermediate stream 124. For instance, the purification stage 116 may include one or more of the following operations: impurity precipitation, solids removal and divalent impurity selective removal followed by lithium concentration (i.e. water removal). The impurity precipitation may comprise coagulation-flocculation. The divalent impurity selective removal may comprise a selective electrochemical separation process, which may utilize an impurity selective membrane, and/or a divalent impurity capture using an ion exchange resin. One embodiment of the purification process includes routing the stream derived from the lithium intermediate (i.e. lithium intermediate or a derivative thereof) to an impurity precipitation operation that uses coagulation-flocculation to yield a precipitate stream, routing the precipitate stream or a derivative thereof to solids removal to yield a filtered precipitate stream and a precipitate and routing the filtered precipitate stream or a derivative thereof to the divalent impurity selective removal to yield the purified stream. The purified stream can then be concentrated, where any membrane separation process (including counter-flow reverse osmosis, reverse osmosis or a combination thereof) may be used. Enhanced or mechanical evaporators may be used as well. The resulting lithium concentrate may have a TDS (total dissolved solids) over 120,000 mg/l preferably over 200,000 mg/l.

A lithium concentrate 126 is produced by the purification stage 116 along with one or more removed streams 128. The removed streams 128 are generally aqueous streams that can have lithium and elevated levels of impurities such as sodium, potassium, calcium, and magnesium. The lithium in the removed streams 128 is sometimes recovered, at least partially, by returning some of all of the removed streams 128 to the extraction stage 114. Depending on the concentration of impurities and lithium in the removed streams 128, all or part of the removed streams 128 can be used as, or included in, the stripping material 122. Additionally or instead, all or part of the removed streams 128 can be mixed with the extraction stage feed 112 to re-process the removed streams 128 in the extraction stage 114.

The lithium concentrate 126 can be routed to the conversion stage 118 where lithium chloride is converted to lithium hydroxide monohydrate by treatment with sodium hydroxide via an intermediate or directly, or directly to lithium carbonate by treatment with sodium carbonate, or both. The conversion stage 118 which may include processes to maximize lithium concentration, before and/or after conversion, produces a lithium product 130, which is for instance hydroxide, carbonate, or both, and an aqueous byproduct 132 that is usually mostly water and sodium chloride, but may include some unreacted hydroxide and/or carbonate ions. The aqueous byproduct 132 can be routed to disposal or re-used in the process 104. For example, where concentration of lithium streams in the conversion stage 118 results in lithium being separated into the byproduct 132, the byproduct can be routed to the purification stage 116 or to the extraction stage 114. Where the byproduct 132 contains unreacted hydroxide and/or carbonate, those can be neutralized, if necessary, by appropriate treatments (HCl to neutralize OH⁻ or make CO₂ from carbonate; CaCl₂ to precipitate CO₃²⁻). Unreacted hydroxide and/or carbonate can also be recycled internally within the conversion stage 118. The byproduct 132 can also be used to adjust pH of the dilute lithium solution 110 from the leaching process 102, which may have low pH, to a higher pH.

In this case, lithium from the leaching process 102 is added to the lithium-selective extraction process 104 for recovery. The dilute lithium solution 110 from the leaching process 102 is usually added to the extraction stage 114 of the lithium-selective extraction process 104. All or part of the dilute lithium solution 110 can be routed to the extraction stage 114 independently from the extraction stage feed 112 or mixed with the extraction stage feed 112. In some cases, for example where impurity content of the dilute lithium solution 110 is low, the dilute lithium solution 110 may be added directly to the purification stage 116. In other cases, the dilute lithium solution 110 could be subjected to an independent concentration operation to increase lithium content so a resulting concentrated lithium solution from the leaching process 102 could be added to the purification stage 116 without diluting lithium content of any streams of the purification stage 116.

The aqueous stream 106 can be sourced, entirely or in part, from the lithium-selective extraction process 104. Many of the streams separated from the lithium streams of increasing concentration, in the process 104, are low in lithium concentration and relatively higher in concentration of impurities. Such streams are highly selective solvents for lithium, compared to other alkali metals and alkaline earth metals, because with a base load of impurity ions, the capacity of such streams to dissolve additional impurity ions is reduced. Thus, any or all of the depleted material 121, the removed stream 128, and the byproduct 132 can be used to leach lithium from the earth material 108 to form the dilute lithium solution 110, which is returned to the process 104. The streams 121, 128, and 132 can be blended in any convenient proportion, and can be supplemented with other aqueous materials, such as water, salt solutions, acid solutions, or salt-acid solutions to achieve any optimal leaching fluid. The streams 121, 128, and 132 can also be used to adjust temperature, pH, total dissolved solids, or other parameters of the leaching fluid. Temperature of the leaching fluid can also be independently adjusted for optimal leaching.

A control system can manage the compositional balance of the processes 102 and 104 to achieve the most efficient and effective lithium extraction. Ion analyzers, pH analyzers, conductivity analyzers, density analyzers, elution analyzers, and the like can be used to output signals representing properties of various streams of the processes 102 and 104, and a controller can be configured to adjust parameters of the streams, such as flow rates and temperatures, to manage operation of the stages of the process 104. The control system can use any convenient model, expert system, machine learning system, or the like to determine targets for the processes 102 and 104 based on known techniques for controlling manufacturing processes.

The control system can also be configured to maintain water balance of the processes 102 and 104. Careful use, separation, and re-use of aqueous streams of the lithium-selective extraction process 104 is typically effective to minimize or prevent incremental handling of water. Water enters the process 100 from the aqueous source 120, the stripping material 122, and any make-up water added to the leaching fluid 106. Water can leave the process 100 through any of the depleted material 121, the removed stream 128, the byproduct stream 132, and the lithium product 130. The controller can be configured to monitor the trend of the water balance using the flow rates and compositions of these streams.

The earth material 108 can add a wide variety of impurity metals to the process 100. For example, metals such as iron, silver, gold, copper, and tin are found in various clays in diverse amounts. Organic materials can also be found in earth materials that can yield lithium. Particulate solids can also be fluidized and entrained with the dilute lithium solution 110. Such impurities can be removed from the dilute lithium solution 110 by known treatments that can include filtration using various media such as activated carbon, magnesium dioxide, and resin media. Other impurities, including metals and various anions, can be removed using filtration methods such as membrane filtration, reverse osmosis, dialysis processes, and the like. A staged filtration process, with at least some recycling of reject streams, can help increase separation efficiency between lithium and impurity materials.

The lithium-selective extraction process 104 may include a pretreatment 111 to condition streams for extraction in the extraction stage 114. The pretreatment adjusts composition of streams, for example reducing impurities, increasing lithium concentration, and/or adjusting pH, to optimize or otherwise facilitate processing in the extraction stage. The pretreatment 111 is optional, and may be included in a way that permits bypassing the pretreatment 111, or using the pretreatment 111, for every stream that can be provided to the extraction stage 114. Thus, the dilute lithium solution 110 can be provided to the pretreatment 111, material from the aqueous lithium source 120 can be provided to the pretreatment 111, and the removed stream 128 can be provided to the pretreatment 111. In particular, the pretreatment 111 can be used to remove any trace organics that might be leached from the earth material 108 into the dilute lithium solution 110. The pretreatment 111 can also be used to remove any other trace impurities that might not be removed or adequately reduced in concentration in the purification stage 116.

The pretreatment 111 can include processes to condition materials to be provided to the extraction stage 114 as needed and as required and/or defined by the source of the materials. For example, where a source includes particular impurities that may be unhelpful for downstream processing, the pretreatment 111 can include processes for removing such impurities. The pretreatment 111 can include filtration processes for removing particulate impurities, ions, organisms, or any other impurities. The pretreatment 111 can also include processes for adjusting composition of one or more streams to be provided to the extraction stage 114, such as concentration, pH adjustment, total dissolved solids, ion ratios, and the like. The pretreatment 111 can also add processing aids, and can adjust other parameters, such as temperature.

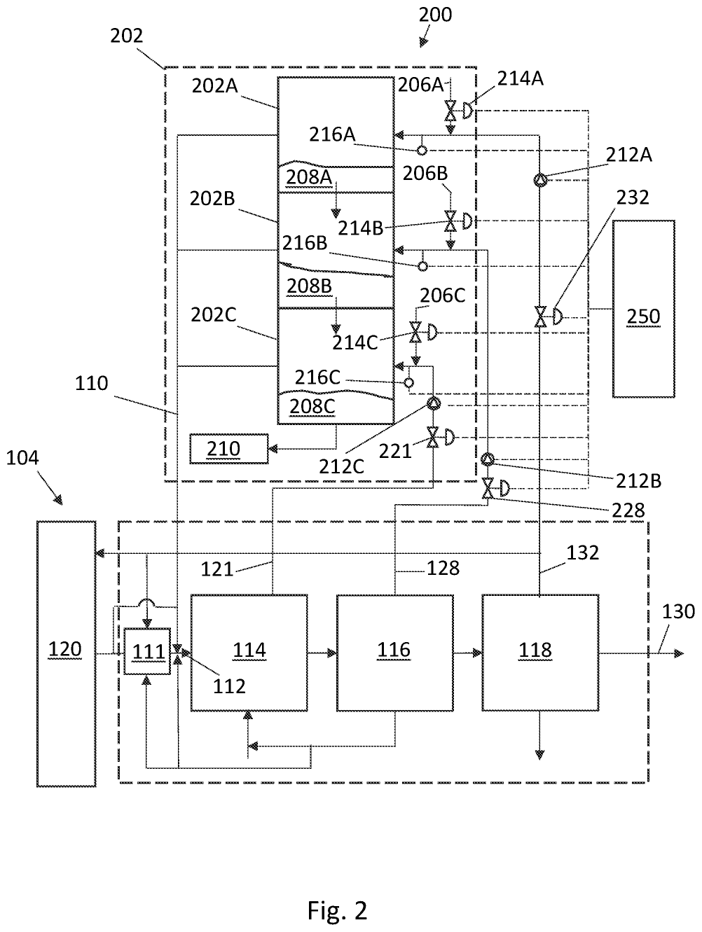

FIG. 2 is a schematic flow diagram summarizing a lithium recovery process 200 according to another embodiment. As in the process 100, the process 200 has a leaching process 202 coupled with the lithium-selective extraction process 104. In this case, the leaching process 202 is a staged process with a plurality of leaching stages that use streams from the process 104 in targeted ways.

The leaching stages are serially arranged, with a first leaching stage 202A coupled to a second leaching stage 202B, in turn coupled to a third leaching stage 202C. In the first leaching stage 202A, a first earth material 208A is subjected to a first leaching to form a second earth material 208B, which is transferred to the second leaching stage 202B. In the second leaching stage 202B, the second earth material 208B is subjected to a second leaching to form a third earth material 208C, which is transferred to the third leaching stage 202C. In the third leaching stage 202C, the third earth material 208C is subjected to a third leaching, after which the third earth material 208C is routed to remediation 210 and can be returned to the environment or used another way.

In each of the stages 202A-C, a stream from the process 104 is used as at least part of the leaching fluid. The stream used at each stage is selected based on lithium content of the stream. The stream with the highest lithium content is used as at least part of the leaching fluid in the first leaching stage 202A. The stream with intermediate lithium content is used as at least part of the leaching fluid in the second leaching stage 202B. The stream with the lowest lithium content is used as at least part of the leaching fluid in the third leaching stage 202C. In this case, the process 104 is operated such that the depleted aqueous material 121 has the lowest lithium content, the removed stream 128 has an intermediate lithium content, and the byproduct 132 has the highest lithium content. As leaching of the earth material progresses, the earth material has lower lithium content at each successive leaching stage, so a leaching fluid with lower lithium content is used to leach the lithium from the earth material.

At each stage 202A-C, a supplemental leaching fluid 206 can be added to the leaching fluid for the stage. Thus, at the first leaching stage 202A, a first supplemental leaching fluid 206A can be added to the depleted aqueous material 121 to form a first leaching fluid mixture. At the second leaching stage 202B, a second supplemental leaching fluid 206B can be added to the removed stream 128 to form a second leaching fluid mixture. At the third leaching stage 202C, a third supplemental leaching fluid 206C can be added to the byproduct 132 to form a third leaching fluid mixture.

The temperature of each leaching stage 202A-C can be selected to optimize leaching of lithium from the earth material at each stage. In one example, the temperature of each leaching stage 202B and C can be higher than the temperature at the previous leaching stage. Thus, the operating temperature of the second leaching stage 202B can be selected and controlled at a higher temperature than the operating temperature of the first leaching stage 202A, and the operating temperature of the third leaching stage 202C can be selected and controlled at a higher temperature than the operating temperature of the second leaching stage 202B. In some cases, it is believed that higher temperature will promote removal of lithium from earth materials by leaching. The operating temperature at each leaching stage 202A-C can be controlled using a thermal controller 212 coupled to each stream of the process 104 being used to form leaching fluid for the respective stage. Thus, a first thermal controller 212A can be coupled to the depleted aqueous material 121 to control the operating temperature of the first leaching stage 202A, a second thermal controller 212B can be coupled to the removed stream 128 to control the operating temperature of the second leaching stage 202B, and a third thermal controller 212C can be coupled to the byproduct 132 to control the operating temperature of the third leaching stage 202C.

A controller 250 can be configured to control the process 200. The controller 250 can be configured as described above in connection with the process 100 to control the process 104. The controller 250 can also be configured to control the staged leaching process 202. Thus, the controller 250 can be operatively coupled to flow controllers for each of the depleted aqueous material 121, the removed stream 128, and the byproduct 132 being routed to the process 202 to monitor and control flow rates of those streams. Thus, the controller 250 can be operatively coupled to a depleted aqueous stream flow controller 221 to monitor and control flow rate of the depleted aqueous material 121 to the first leaching stage 202A. The controller 250 can be operative coupled to a removed stream flow controller 228 to monitor and control flow rate of the removed stream 128 to the second leaching stage 202B. The controller 250 can be operatively coupled to a byproduct flow controller 232 to monitor and control flow rate of the byproduct 132 to the third leaching stage 202C. The controller 250 can also be operatively coupled to flow controllers 214A-C for each of the first, second, and third supplemental leaching fluids 206A-C, respectively, to monitor and control flow rates of those streams. Composition analyzers 216A-C, which can include ion analyzers and pH analyzers, can be coupled to each leaching fluid mixture and operatively coupled to the controller 250 to allow the controller 250 to monitor and control composition of the first leaching fluid mixture for the first leaching stage 202A, the second leaching fluid mixture for the second leaching fluid stage 202B, and the third leaching fluid mixture for the third leaching fluid stage 202C. The controller 250 can also be operatively coupled to the thermal controllers 212A-C to monitor and control temperature of each respective stream.

At each leaching stage 202A-C, a leached lithium material is recovered. The leached lithium material from each leaching stage is combined to form the dilute lithium solution 110 that is provided to the extraction stage 114 of the lithium-selective extraction process 104. In alternate embodiments, each leached lithium material can be provided to the process 104 at different locations depending on the lithium content of each leached lithium material. As in the process 100, impurity metals, solids, and organics that may be present in the dilute lithium solution 110 may be removed by filtration operations selected to remove the particular impurities. The pretreatment 111 can be used for such impurity removal.

The apparatus described herein enable performance of a method of recovering lithium by leaching lithium from an earth material to form a dilute lithium solution and providing the dilute lithium solution to a lithium-selective extraction process to recover the lithium from the dilute lithium solution. Aqueous streams from the lithium-selective extraction process can be used to leach lithium from the earth material, and can be directly reused in the lithium-selective extraction process. The aqueous streams from the lithium-selective extraction process can be used in a staged leaching operation, according to their lithium content, to improve leaching of lithium from the earth material. Trace impurities from the earth material, such as metals, organics, and solids, can be removed from the dilute lithium solution by filtration or other suitable process before the dilute lithium solution is provided to the lithium-selective extraction process. Other aqueous lithium sources can be concurrently processed using the lithium-selective extraction process. All streams processed using the lithium-selective extraction process can be subjected to a pretreatment to adjust composition, such as impurity content, water content, pH, and total dissolved solids, and/or temperature.

The lithium-selective extraction process performs an extraction process, a purification process, and optionally a conversion process to yield a lithium product. The extraction process may use a lithium-selective medium to withdraw lithium from a lithium-bearing aqueous stream into or onto the medium to yield a lithium-depleted stream. A stripping material is contacted with the loaded medium to remove the lithium from the loaded medium, yielding an aqueous lithium intermediate. The extraction process can yield a large increase in concentration of lithium from a low concentration in the feed to the extraction process, in some cases as low as 70 ppm, to an intermediate concentration, for example 8,000 to 10,000 ppm, in the lithium intermediate. The lithium-selective medium can be liquid or solid, and the contacting can be performed by intimate mixing, fixed bed, or fluidized bed contact. The lithium-depleted stream can be used to leach lithium from the earth material in the leaching process. Alternatively or additionally, the extraction process may use a electrochemical separation process with a Lithium selective membrane.

The purification process involves further increasing the concentration of lithium and reducing the concentration of impurities, for instance as disclosed in relationship with FIG. 1. The lithium intermediate is the main feed for the purification process, although a reclaimed salt solution from the atmospheric evaporation process can be blended with the lithium intermediate for purification processing. The purification process uses any combination of filtration, for example membrane filtration, evaporation, and precipitation to remove impurity ions like sodium, potassium, calcium, and magnesium, generally yielding a lithium concentrate stream and an impurity stream. The impurity stream can be used to leach lithium from the earth material in the leaching process. The purification process can provide an increase in lithium concentration of 10-20 times in the lithium concentrate stream relative to the lithium intermediate.

The conversion process involves converting lithium chloride in the lithium concentrate stream to lithium carbonate or lithium hydroxide monohydrate, generally by reaction with sodium carbonate or sodium hydroxide. In some cases, both products can be made. The conversion process may also involve concentrating lithium further to expedite the conversion reactions. The conversion process generally yields a lithium product, which can be a slurry or dry product of lithium carbonate or lithium hydroxide monohydrate, or both separate products, along with an aqueous byproduct stream that can contain sodium, trace amounts of potassium, calcium, and magnesium, and unreacted hydroxide and carbonate ions. The aqueous byproduct stream can be used to leach lithium from the earth material in the leaching process.

The extraction stage 114, purification stage 116, and optional conversion stage 118 of the lithium-selective extraction process 104 can be located adjacent, one to the other, or one or more of the stages 114, 116, and 118 can be remotely located, one from the other. Thus, representation in the figures of a process boundary of the process 104 is not to be interpreted as a physical boundary or geographic boundary. Likewise, the lithium-selective extraction process 104 can be located adjacent to the leaching process 102, or can be located remote from the leaching process 102.

The lithium-selective processes described herein can be used to extract, concentrate, and purify other elements, such as nickel, manganese, magnesium, and cobalt, zinc, aluminum, copper, molybdenum, vanadium, or any combination thereof. Generally, where the processes herein are described as lithium-selective, materials can be used to make the same processes selective for other target ions, such as those listed above. In such cases, an appropriate fluid is used to leach the target ion from the earth material. Selectivity of the fluid can also be controlled or adjusted by setting temperature of the fluid, since solubility of ions in fluids generally changes with temperature of the fluid. The resulting target solution can then be subjected to an extraction process and/or impurity removal process that is substantially the same as the processes described herein, but using materials selective for the target ion to extract, concentrate, and purify the target ion by removing impurities without removing the target ion.

Embodiments described herein relate to a method, comprising leaching a target ion from an earth material to form a target solution; and extracting the target ion from the target solution using an extraction process selective for the target ion to yield a concentrate.

The method may further comprise converting the target ion in the concentrate to a product.

The target ion may include lithium, nickel, manganese, cobalt, iron, zinc, vanadium, molybdenium, copper, aluminum, magnesium, or any combination thereof. In an embodiment, the target ion includes lithium.

In an embodiment, converting the target ion in the concentrate to a product is performed in a conversion stage of the extraction process.

Leaching the target ion from the earth material may comprise contacting the earth material with a material from the selective extraction process. In particular, leaching the target ion from the earth material may comprise contacting the earth material with a plurality of materials from the selective extraction process in stages according to target ion content and/or other parameters such as temperature, pH, total dissolved solids, of the materials from the selective extraction process. Leaching may be performed at reduced pH. In such embodiment, the plurality of materials from the selective extraction process may include, at least, a depleted aqueous stream from an extraction stage, a removed stream from a purification stage, and a byproduct from a concentration stage.

In an embodiment, an operating temperature of each leaching stage is separately controlled.

The method may further comprise concurrently extracting the target ion from a source containing the target ion using the extraction process.

In an embodiment, extracting the target ion from the target solution using an extraction process selective for the target ion also yields a depleted stream, which is depleted of the target ion, and further comprising returning the depleted stream to the environment. In such embodiment, returning the depleted stream to the environment may comprise injecting the depleted stream underground at a depth selected such that a temperature at the depth is above a precipitation temperature of the depleted stream.

In an embodiment, extracting target ion from an aqueous source comprises blending a material from the aqueous source with the target solution to form an extraction feed and extracting the target ion from the extraction feed. It may include monitoring a property of the target solution and of the material from the aqueous source, and the blending is performed based on a target for the property in the extraction feed.

In an embodiment, where the target ion is lithium, the product may be lithium carbonate, lithium hydroxide, lithium chloride, lithium sulfate, lithium metal, or any combination thereof.

In an embodiment, extracting the target ion using the selective extraction process includes contacting the target solution with a material selective for the target ion to remove the target ion from the target solution and unloading the target ion from the selective material using a stripping material to form an intermediate. Alternatively or additionally, extracting the target ion using the selective extraction process includes performing an electrochemical separation selective for the target ion to yield the concentrate. A selective electrochemical separation uses a electrochemical cell and a membrane selective for the target ion.

In an embodiment, extracting the target ion from the target solution using an extraction process selective for the target ion to yield a concentrate wherein the extraction process yields an intermediate, and wherein extracting further includes a purification process to yield the concentrate from the intermediate, wherein the purification process includes one or more of water removal and impurity removal. The purification stage may include an ion exchange process, a filtration processes, an osmotic process, an evaporation process, a redox process, an electrochemical processes, a solids removal process, an enhanced or mechanical evaporation process, or any combination thereof. In a specific embodiment, the purification stage includes a water removal stage using a reverse osmosis process, counter-flow reverse osmosis process or any combination thereof. In particular, such water removal stage may be configured so that the TDS of the concentrate is above 120,000 mg/l.

In an embodiment, the earth material is a clay, such as Montmorillonite clay, boron clay, and hectorite.

The disclosure also relates to a method including leaching a target ion such as lithium ion from an earth material to form a target solution such as a dilute lithium solution; extracting the target ion from the target solution using an extraction stage of an extraction process selective for the target ion; concurrently extracting the target ion from an aqueous source using the extraction stage, wherein leaching the target ion from the earth material comprises contacting the earth material with a material from the selective extraction process.

In an embodiment, extracting the target ion from the aqueous solution and concurrently extracting the target ion from the aqueous source forms an intermediate, and further comprising purifying the intermediate to form a concentrate. The method may further comprise converting target ion of the concentrate to a product. The target ion may for instance be one of lithium, nickel, manganese, cobalt, iron, zinc, copper, aluminum, vanadium, molybdenum, or magnesium, or a combination thereof.

In an embodiment, extracting the target ion from the target solution and concurrently extracting the target ion from the aqueous source includes combining the target solution and the aqueous source into a feed, and routing the feed to the extraction stage. In an embodiment, the extraction stage includes contacting the feed with a material selective from the target ion, and unloading target ion from the selective material using a stripping material to form a concentrate. Alternatively or additionally, the extraction stage includes performing a electrochemical separation selective for the target ion on the feed to form a concentrate. A selective electrochemical separation uses a electrochemical cell and a membrane selective for the target ion.

Leaching the target ion from the earth material may comprise contacting the earth material with a material from the selective extraction process. In particular, leaching the target ion from the earth material may comprise contacting the earth material with a plurality of materials from the selective extraction process in stages according to target ion content and/or other parameters such as temperature, pH, total dissolved solids, of the materials from the selective extraction process. Leaching may be performed at reduced pH. In such embodiment, the plurality of materials from the selective extraction process may include, at least, a depleted aqueous stream from an extraction stage, a removed stream from a purification stage, and a byproduct from a concentration stage.

In an embodiment, an operating temperature of each leaching stage is separately controlled.

In an embodiment, the method further comprises purifying the intermediate and the aqueous solution to form a concentrate and optionally converting target ion of the concentrate to the product, wherein purifying includes one or more of removing water and removing impurities. The purification stage may include an ion exchange process, a filtration processes, an osmotic process, an evaporation process, a redox process, an electrochemical processes, a solids removal process, an enhanced or mechanical evaporation process, or any combination thereof. In a specific embodiment, the purification stage includes a water removal stage using a reverse osmosis process, counter-flow reverse osmosis process or any combination thereof. In particular, such water removal stage may be configured so that the TDS of the concentrate is above 120,000 mg/l.

In an embodiment, extracting the target ion from the aqueous source also yields a depleted stream, which is depleted of the target ion, and further comprising returning the depleted stream to the environment. In such embodiment, returning the depleted stream to the environment may comprise injecting the depleted stream underground at a depth selected such that a temperature at the depth is above a precipitation temperature of the depleted stream.

The target ion may be lithium and the product may be lithium carbonate, lithium hydroxide, lithium chloride, lithium sulfate, lithium metal, or any combination thereof.

In an embodiment, the earth material is a clay, such as Montmorillonite clay, boron clay, and hectorite.

The disclosure also relates to a method, comprising leaching a target ion from an earth material to form a target solution; wherein the target ion is lithium, nickel, manganese, cobalt, iron, zinc, vanadium, copper, aluminum or molybdenum or magnesium, or a combination thereof; concurrently extracting target ion from an aqueous source distinct from the target solution using a extraction process selective for the target ion; adding a material derived from the target solution to the selective extraction process.

The method may also include converting target ion from the target solution and aqueous source to a product.

In an embodiment, the extraction process includes an extraction stage and a purification stage, wherein the extraction stage selectively extracts the target ion from the aqueous source and wherein the purification stage removes water or impurities from an intermediate obtained from the extraction stage. The target solution may be added to the extraction stage or the purification stage of the selective extraction process to form a concentrate containing the target ion from the target solution and the aqueous source. The method may also include converting the target ion from the aqueous source and the target solution to a product in a conversion process comprises converting the target ion from the concentrate to the product.

In an embodiment, the target solution is added to an extraction stage of the selective extraction process to form an intermediate containing target ion from the target solution and the aqueous source, and converting the target ion from the aqueous source and the aqueous solution to a product in a conversion process comprises converting the target ion from the intermediate to the product.

Leaching the target ion from the earth material may comprise contacting the earth material with a material from the selective extraction process. In particular, leaching the target ion from the earth material may comprise contacting the earth material with a plurality of materials from the selective extraction process in stages according to target ion content and/or other parameters such as temperature, pH, total dissolved solids, of the materials from the selective extraction process. Leaching may be performed at reduced pH. In such embodiment, the plurality of materials from the selective extraction process may include, at least, a depleted aqueous stream from an extraction stage, a removed stream from a purification stage, and a byproduct from a concentration stage.

In an embodiment, concurrently extracting the target ion from the target solution using an extraction process selective for the target ion also yields a depleted stream, which is depleted of the target ion, and further comprising returning the depleted stream to the environment. In such embodiment, returning the depleted stream to the environment may comprise injecting the depleted stream underground at a depth selected such that a temperature at the depth is above a precipitation temperature of the depleted stream.

In an embodiment, where the target ion is lithium, the product may be lithium carbonate, lithium hydroxide, lithium chloride, lithium sulfate, lithium metal, or any combination thereof.

In an embodiment, extracting the target ion using the selective extraction process includes contacting the target solution with a material selective for the target ion to remove the target ion from the target solution and unloading the target ion from the selective material using a stripping material to form an intermediate. Alternatively or additionally, extracting the target ion using the selective extraction process includes performing an electrochemical separation selective for the target ion to yield the concentrate. A selective electrochemical separation uses a electrochemical cell and a membrane selective for the target ion.

In an embodiment, extracting the target ion from the target solution using an extraction process selective for the target ion to yield a concentrate wherein the extraction process yields an intermediate, and wherein extracting further includes a purification process to yield the concentrate from the intermediate, wherein the purification process includes one or more of water removal and impurity removal. The purification stage may include an ion exchange process, a filtration processes, an osmotic process, an evaporation process, a redox process, an electrochemical processes, a solids removal process, an enhanced or mechanical evaporation process, or any combination thereof. In a specific embodiment, the purification stage includes a water removal stage using a reverse osmosis process, counter-flow reverse osmosis process or any combination thereof. In particular, such water removal stage may be configured so that the TDS of the concentrate is above 120,000 mg/l.

The method may further comprise monitoring a property of the target solution and selecting a location to add the target solution to the selective extraction process based on the property.

In an embodiment, the earth material is a clay, such as Montmorillonite clay, boron clay, and hectorite.

While the foregoing is directed to embodiments of the present invention, other and further embodiments of the present disclosure may be devised without departing from the basic scope thereof, and the scope thereof is determined by the claims that follow.

We claim:

1. A method, comprising:
leaching a target ion from an earth material to form a target solution; and
extracting the target ion from the target solution using an extraction process selective for the target ion to yield a concentrate.

2. The method of claim 1, wherein the target ion is lithium, nickel, manganese, cobalt, or magnesium, zinc, aluminum, copper, molybdenum, vanadium, or any combination thereof.

3. The method of claim 1, wherein leaching the target ion from the earth material comprises contacting the earth material with a material from the selective extraction process.

4. The method of claim 1, further comprising concurrently extracting the target ion from an aqueous source using the selective extraction process.

5. The method of claim 4, wherein the extracting target ion from an aqueous source comprises blending a material from the aqueous source with the target solution to form an extraction feed and extracting the target ion from the extraction feed.

6. The method of claim 5, further comprising monitoring a property of the target solution and of the material from the aqueous source, and the blending is performed based on a target for the property in the extraction feed.

7. The method of claim 1, wherein leaching the target ion from the earth material comprises contacting the earth material with a plurality of materials from the selective extraction process in stages according to target ion content of the materials from the selective extraction process.

8. The method of claim 1, wherein extracting the target ion using the selective extraction process includes contacting the target solution with a material selective for the target ion to remove target ion from the aqueous solution and unloading the target ion from the selective material using a stripping material to form a lithium intermediate.

9. The method of claim 1, wherein extracting the target ion using the selective extraction process includes performing an electrochemical separation selective for the target ion to yield the concentrate.

10. The method of claim 1, wherein extracting the target ion from the target solution using an extraction process selective for the target ion to yield a concentrate also yields an intermediate, and wherein the extraction process includes a purification process that removes water, impurities, or both to yield the concentrate from the intermediate, wherein the purification process includes one or more of water removal and impurity removal.

11. A method, comprising:
leaching a lithium ion from an earth material to form a dilute lithium solution;
extracting the lithium ion from the dilute lithium solution using an extraction stage of an extraction process selective for the lithium ion; and
concurrently extracting the lithium ion from an aqueous source using the extraction stage, wherein leaching the lithium ion from the earth material comprises contacting the earth material with a material from the selective extraction process.

12. The method of claim 11, wherein extracting the lithium ion from the aqueous solution and concurrently extracting the lithium ion from the aqueous source forms an intermediate, and further comprising purifying the intermediate to form a concentrate.

13. The method of claim 11, wherein extracting the lithium ion from the dilute lithium solution and concurrently extracting the lithiumion from the aqueous source includes combining the dilute lithiumt solution and the aqueous source into a feed, and routing the feed to the extraction stage.

14. The method of claim 11, wherein the extraction stage includes contacting the feed with a material selective for the lithium ion in the extraction stage to remove the lithium ion from the feed, and unloading lithium ion from the selective material in the extraction stage using a stripping material to form a concentrate.

15. The method of claim 11, wherein and the extraction stage includes performing a selective electrochemical separation on the feed to form a concentrate.

16. The method of claim 11, wherein leaching the lithium ion from the earth material comprises contacting the earth material with a plurality of materials from the selective extraction process in a plurality of leaching stages according to lithium ion content of the materials from the selective extraction process.

17. The method of claim 11, further comprising converting the target ion in the concentrate to a product, wherein the product is lithium carbonate, lithium hydroxide, lithium chloride, lithium sulfate, lithium metal, or any combination thereof.

18. A method, comprising:
leaching a target ion from an earth material to form a target solution; wherein the target ion includes lithium, nickel, manganese, cobalt, zinc, aluminum, copper, molybdenum, vanadium or magnesium, or any combination thereof;
concurrently extracting target ion from an aqueous source distinct from the target solution using a extraction process selective for the target ion;
adding a material derived from the target solution to the selective extraction process.

19. The method of claim 18, wherein the extraction process includes an extraction stage and a purification stage, wherein the extraction stage selectively extracts the target ion from the aqueous source and wherein the purification stage removes water or impurities from an intermediate obtained from the extraction stage, wherein the target solution is added to the extraction stage or the purification stage of the selective extraction process to form a concentrate containing the target ion from the target solution and the aqueous sourcet.

20. The method of claim 18, further comprising monitoring a property of the target solution and selecting a location to add the target solution to the selective extraction process based on the property.
